(19) United States
(12) Patent Application Publication
(10) Pub. No.: US 2026/0045799 A1
(43) Pub. Date: Feb. 12, 2026

(54) ELECTRIC POWER CONTROL DEVICE

(71) Applicant: HITACHI, LTD., Tokyo (JP)

(72) Inventors: Toru KOUNO, Tokyo (JP); Jun TSUNODA, Tokyo (JP); Eri ISOZAKI, Tokyo (JP); Keito AKIZUKI, Tokyo (JP); Naoki YOSHIDA, Tokyo (JP)

(21) Appl. No.: 19/103,062

(22) PCT Filed: Feb. 27, 2023
(86) PCT No.: PCT/JP2023/007022

§ 371 Date: Feb. 11, 2025

(30) Foreign Application Priority Data
Sep. 13, 2022 (JP) 2022-144964

(51) Int. Cl. H02J 3/32; H02J 3/38; H02J 7/35

(52) U.S. Cl. CPC H02J 3/32; H02J 3/38; H02J 7/35; H02J 2300/24

(57) ABSTRACT

An object of the present invention is to provide a technology capable of accurately controlling according to a predetermined plan, transmitted power when power generated by a power generation system comprised of a solar cell and a storage battery is transmitted between sites via a power transmission network. An electric power control device according to the present invention calculates the power to be charged and discharged by the storage battery, based on the difference between the planned power that was scheduled to be transmitted via the power transmission network and the actual resulting power which was actually transmitted, and calculates the power that the solar cell needs to generate (refer to FIG. 8).

### TECHNICAL FIELD

The present invention relates to a technology for controlling transmitted power when power generated by a power generation system comprised of a solar cell and a storage battery is transmitted between sites via a power transmission network.

### BACKGROUND ART

Self-consignment utilizes a power transmission network owned by an electric power company when a business operator or the like having power generation equipment transmits power generated by the power generation equipment between sites. When executing the self-consignment, it is necessary to submit a power transmission plan to an operating organization (for example: Organization for Cross-regional Coordination of Transmission Operators: OCCTO) before the start of consignment (for example, the day before). Further, while self-consignment is being executed, it is necessary to transmit power as planned in advance at predetermined time intervals (30 minutes, for example). When the actual transmitted power deviates from a predetermined plan (imbalance), a penalty is generally imposed.

The following Patent Document 1 describes, with the objective of “providing a power monitoring control device capable of self-consigning surplus power according to a planned value”, a technology that “a power monitoring control device (10) includes an actual resulting value determination unit (14) which determines whether or not a consignment actual resulting value within a predetermined consignment period has reached an actual resulting value upper limit threshold value, and a control unit (16) which performs consignment suppression control of a target device when the consignment actual resulting value within the consignment period has reached the actual resulting value upper limit threshold value (refer to Abstract).

The following Patent Document 2 describes, with the objective of “providing a rational evaluation method for the minimum capacity of an installed storage battery and the optimal charging and discharging logic for a small capacity storage battery in consideration of the occurrence of prediction errors inherent in a solar radiation amount prediction technology and a storage battery management technology”, a technology that “a storage facility management device 1 includes a charging/discharging plan creation unit 2 which specifies a consignment time zone in which a surplus power predicted value will occur based on a demand power estimated value predicted by referring to a predetermined database 5 and a predicted value of generated power from renewable energy, when the consignment time zone extends over a plurality of unit times more than or equal to a predetermined value, divides the consignment time zone into a plurality of time segments each consisting of one or more of the unit times, formulates a charging/discharging plan for power storage equipment so that consignment power becomes constant for each time segment, and stores the formulated charging/discharging plan in a predetermined storage unit 4” (refer to Abstract).

Although Japanese Patent Application No. 2020-127908 is not related to self-consignment, it describes a method of estimating the amount of solar radiation for a solar cell by converting the operating characteristics of the solar cell into values under a standard amount of solar radiation and a standard temperature.

### CITATION LIST

### Patent Literature

Patent Literature 1: Japanese Unexamined Patent Application Publication No. 2021-141769
Patent Literature 2: Japanese Unexamined Patent Application Publication No. 2020-058141

### SUMMARY OF INVENTION

### Technical Problem

Consider a case in which a power generation system which generates power to be transmitted by self-consignment is comprised of, for example, a solar cell and a storage battery. In order to transmit power while complying with a predetermined plan during executing self-consignment, there is a need to suppress the amount of generated power to be smaller than the maximum power point when the solar cell generates power in excess of scheduled power to be consigned, and allocate a surplus power generation amount to charging of the storage battery. That is, when the amount of power generated from the power generation system exceeds the scheduled power to be consigned planned in advance, the power generation system instructs the solar cell to suppress the amount of generated power below the maximum power point and instructs the storage battery to perform a charging operation.

At this time, it is necessary that the power generated by the solar cell while suppressing from the maximum power point, and the charging power charged to the storage battery are balanced. However, since the IV characteristics (relationship between the output voltage and the output current) of the solar cell vary depending on various factors, it is not always easy to accurately grasp the amount of suppression from the maximum power point. If the amount of power suppression is unknown, it is also difficult to accurately instruct the charging power to be allocated for charging of the storage battery. This can make it difficult to adhere to the predetermined plan.

The present invention has been made in view of the above-described problems. It is an object of the present invention to provide a technology capable of accurately controlling according to a predetermined plan, transmitted power when power generated by a power generation system comprised of a solar cell and a storage battery is transmitted between sites via a power transmission network.

### Solution to Problem

An electric power control device according to the present invention calculates the power to be charged and discharged by the storage battery, based on the difference between the planned power that was scheduled to be transmitted via the power transmission network and the actual resulting power which was actually transmitted, and calculates the power that the solar cell needs to generate.

### Advantageous Effects of Invention

According to the electric power control device according to the present invention, it is possible to accurately control according to the predetermined plan, the transmitted power when the power generated by the power generation system comprised of the solar cell and the storage battery is transmitted between the sites via the power generation network. Problems, configurations, effects, and the like other than those described above will become apparent from the following description of embodiments.

### BRIEF DESCRIPTION OF DRAWINGS

FIG. 1A is an example of a configuration of a power generation system provided by a business operator that implements self-consignment.

FIG. 1B is an example of a configuration of a power generation system provided by a business operator that implements self-consignment.

FIG. 2 is a schematic diagram illustrating the manner in which self-consignment is performed between sites.

FIG. 3 is a diagram describing an imbalance in transmitted power.

FIG. 4A is a schematic diagram describing a method of estimating the amount of solar radiation (expected amount of solar radiation) irradiated to a solar cell.

FIG. 4B is a schematic diagram describing a procedure for predicting the amount of power generated by a solar cell using learning results of FIG. 4A.

FIG. 5 illustrates an example of converting IV characteristics during the normal operation into values under a standard amount of solar radiation and a standard temperature.

FIG. 6 illustrates an example in which an operating point where the amount of power generation is suppressed below the maximum power point is converted into a value under a standard amount of solar radiation and a standard temperature.

FIG. 7 is a flowchart describing a procedure of estimating a variable j and the expected amount of solar radiation.

FIG. 8 is a flowchart describing a procedure by which an electric power control device 1 suppresses power transmission imbalance while implementing self-consignment.

FIG. 9 is a flowchart describing a procedure of determining a likelihood c.

FIG. 10A is an example of a user interface provided by the electric power control device 1.

FIG. 10B is an example of the user interface provided by the electric power control device 1.

FIG. 10C is an example of the user interface provided by the electric power control device 1.

### DESCRIPTION OF EMBODIMENTS

### First Embodiment

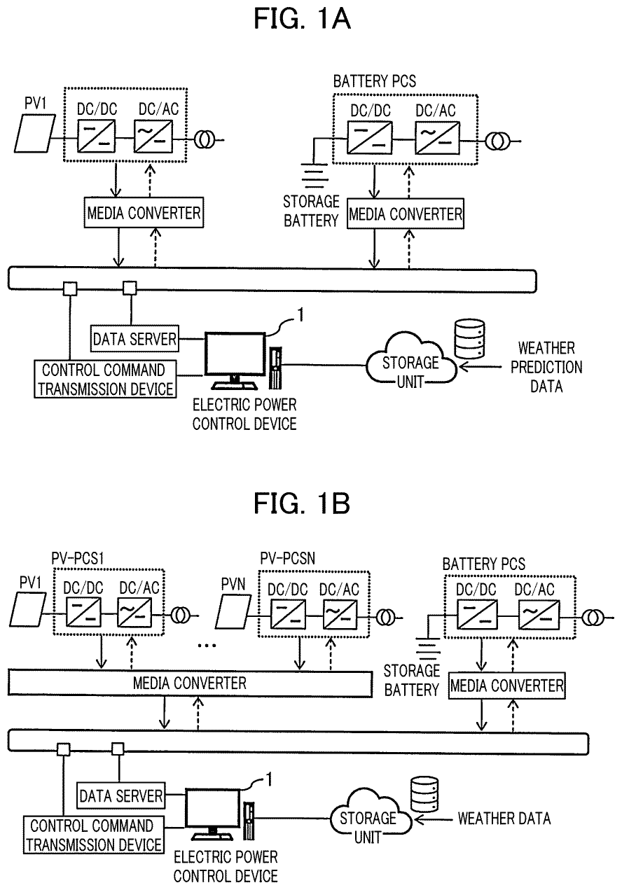

FIG. 1A and FIG. 1B are each an example of a configuration of a power generation system provided by a business operator that implements self-consignment. A power generation system is comprised of a solar cell (PV) and a storage battery (battery). The solar cell is connected to a power transmission network via a DCDC converter and a DCAC converter. The same applies to the storage battery. An electric power control device 1 transmits operation commands to a drive device of the solar cell and a drive device of the storage battery (each constituted by the converter described above) to thereby control the respective operations of the solar cell and the storage battery. There is a case where both of the plural solar cells and the plural storage batteries are arranged.

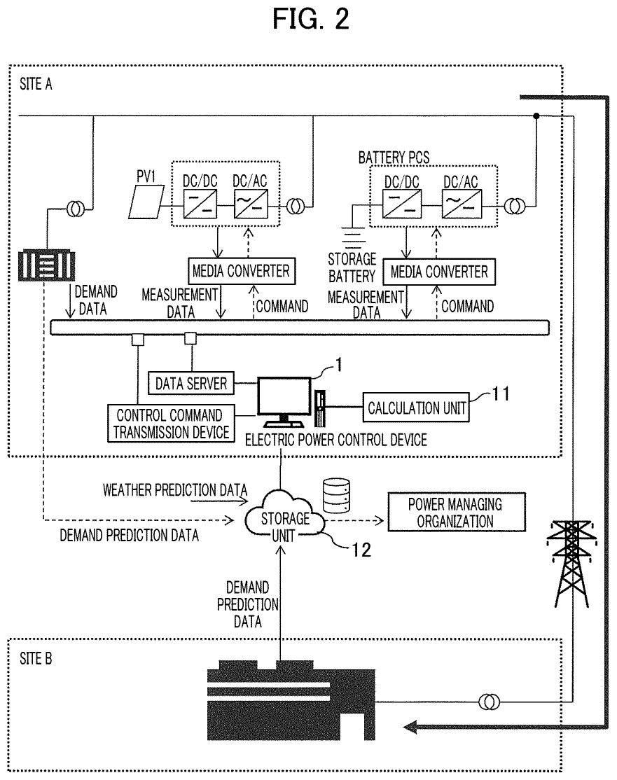

FIG. 2 is a schematic diagram illustrating the manner in which self-consignment is performed between sites. A site A includes the power generation system described in FIGS. 1(a) and 1(b). Power generated in the site A is transmitted to a site B via a power grid. The electric power control device 1 controls transmitted power based on demand prediction data, measurement data of each facility, etc. according to a procedure to be described later. The electric power control device 1 includes a calculation unit 11 and a storage unit 12. These will be described later.

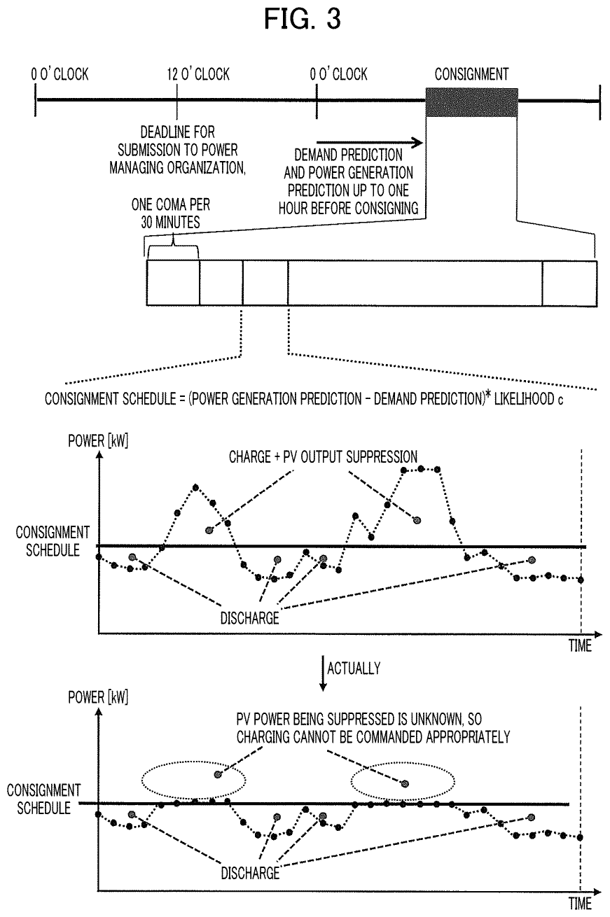

FIG. 3 is a diagram describing an imbalance in transmitted power. Before performing self-consignment (for example, the day before), the business operator submits a consignment plan descriptive of the scheduled power to be consigned in units of, for example, 30 minutes to a power managing organization. The scheduled power to be consigned is determined by, for example, subtracting demand prediction from power generation amount prediction by the power generation system and multiplying its result by a coefficient (≤1.0). This coefficient is a coefficient for allowing the power generation system to have operating capacity. In the present embodiment, it will be referred to as a likelihood. By instructing the solar cell to generate power based on the result of multiplying the likelihood, the solar cell will operate at an operating point to output less power than at the maximum power point.

When the actual generated power exceeds the scheduled power to be consigned, its excess portion is balanced by suppressing the output power of the solar cell below the maximum power point and charging the storage battery. When the actual generated power falls short compared to the scheduled power to be consigned, the shortfall is compensated for by discharging from the storage battery.

In order to grasp how much the output of the solar cell has been suppressed from the maximum power point (i.e., how much power can be charged to the storage battery), there is a need to obtain the maximum power point of the solar cell. The maximum power point of the solar cell is an operating point where the product of the voltage and current in the IV characteristics of the solar cell becomes maximum. However, since the IV characteristics vary depending on various factors, it is not always easy to accurately grasp them. Therefore, it is not always easy to accurately determine the maximum power point and the amount of suppression from the maximum power point. Further, according to this, it is difficult to judge whether or not the likelihood c is approximately set. This is because the likelihood c is set using the maximum power point as a reference.

In view of the above-described problems in the conventional self-consignment system, the present invention aims to provide a technology capable of accurately controlling transmitted power in self-consignment and thereby suppressing penalties associated with the power transmission imbalance. Hereinafter, a method for predicting the amount of power generation of the power generation system (solar cell) will be described first, and then a method for controlling the power to be consigned using the power generation amount prediction will be described.

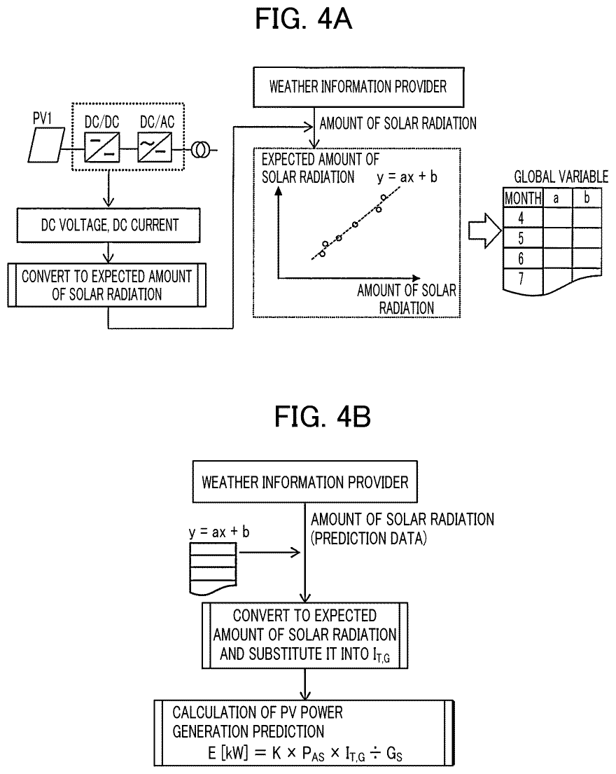

FIG. 4A is a schematic diagram describing a method of estimating the amount of solar radiation (expected amount of solar radiation) irradiated to a solar cell. The electric power control device 1 acquires the results of measuring the output voltage and output current of the solar cell from, for example, an electric power conversion device (DCDC converter which drives the solar cell, or the like). The electric power control device 1 uses the measurement results to estimate the expected amount of solar radiation to the solar cell. A method for estimating the expected amount of solar radiation will be described later.

Aside from this, the electric power control device 1 acquires solar radiation amount prediction (or measurement results) from a weather information provider or the like. The electric power control device 1 learns a correspondence relation between the solar radiation amount prediction and the expected amount of solar radiation by machine learning or the like and stores the result thereof. Here, there is shown an example in which the two have a correspondence relation expressed by a linear function like that in FIG. 4A. In this case, the electric power conversion device learns a coefficient ab every month, for example.

The solar radiation amount prediction provided by the weather information provider is the result of predicting (measuring) the amount of solar radiation in a certain area. On the other hand, it is conceivable that only a portion of the amount of solar radiation is irradiated to the solar cell. However, it is conceivable that the amount of solar radiation in an area and the amount of solar radiation to the solar cell have a correspondence relationship. By learning this relationship, the electric power control device 1 can estimate the expected amount of solar radiation applied to the solar cell from the solar radiation amount prediction. FIG. 4A illustrates this.

FIG. 4B is a schematic diagram describing a procedure for predicting the amount of power generated by a solar cell using learning results of FIG. 4A. The electric power control device 1 obtains the expected amount of solar radiation by applying the solar radiation amount prediction obtained from the weather information provider to the learning result. The electric power conversion device substitutes the expected amount of solar radiation into the following formula to calculate the power generation amount prediction E of the solar cell.

$$E [ kW ] = K \times {P}_{A S} \times {I}_{T , G} \div {G}_{S}$$

$$K = {K}^{′} \cdot {K}_{P T} \cdot {e}_{d}$$

K′: constant (array loss 0.97)
e_{d}: deterioration coefficient

$${K}_{PT} = 1 + {α}_{PMAX} \cdot ( {T}_{PA} - 25 ) / 100$$

$${α}_{PMAX} : \% / ° C$$

T_{PA}: battery temperature
P_{AS}: rating
I_{T,G}: inclined amount of solar radiation (expected amount of solar radiation)
G_{S}: standard amount of solar radiation

Next, a description will be made about the method for estimating the expected amount of solar radiation. The expected amount of solar radiation can be estimated by using the same physical model and method as in Japanese Patent Application No. 2020-127908. This method is for obtaining the expected amount of solar radiation by converting the operating characteristics of the solar cell into values under the standard amount of solar radiation and the standard temperature. However, in the same application, since the same method is used in the context of detecting partial wire breaks and partial shadows, the estimating method in the present application will be described again.

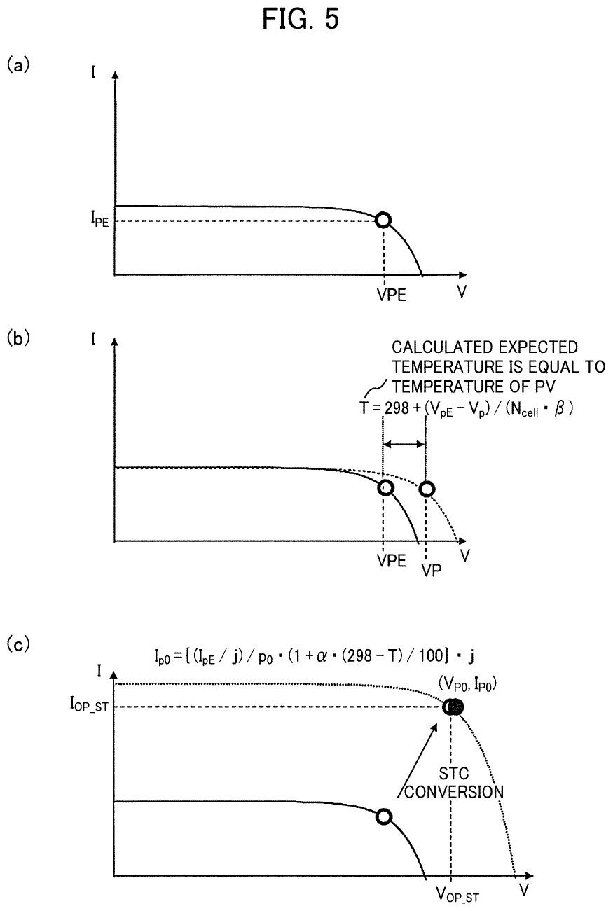

FIG. 5 illustrates an example of converting IV characteristics during the normal operation into values under a standard amount of solar radiation and a standard temperature. It is assumed that the solar cell is operating at an operating voltage V_{PE} and an operating current I_{PE} (FIG. 5(a)). During the normal operation, when the temperature of the solar cell is calculated by a procedure to be described later, the calculated temperature matches well with the actual temperature of the solar cell (FIG. 5(b)). Further, when the operating voltage V_{PE} and the operating current I_{PE} are converted into values (V_{P0}, I_{P0}) under the standard amount of solar radiation and the standard temperature (refer to as Standard Condition: STC) by the procedure to be described later, the converted values match well with a standard operating current I_{OP_ST} and a standard operating voltage V_{OP_ST} which are defined as product specification values at the standard amount of solar radiation and the standard temperature (FIG. 5(c)).

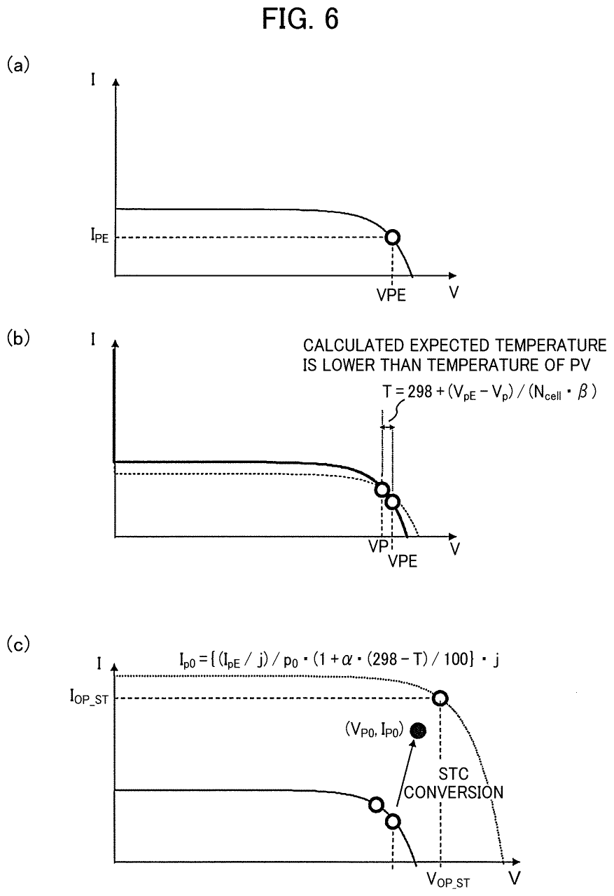

FIG. 6 illustrates an example in which an operating point where the amount of power generation is suppressed below the maximum power point is converted into a value under a standard amount of solar radiation and a standard temperature. It is assumed that the solar cell is operating at an operating voltage V_{PE} and an operating current I_{PE} (FIG. 6(a)). This operating point is more suppressed than the maximum power point. When the temperature of the solar cell is calculated by the procedure described later, the calculated temperature is smaller than the actual temperature of the solar cell (FIG. 6(b)). In this case, when the operating voltage V_{PE} and the operating current I_{PE} are converted into values (V_{P0}, I_{P0}) under the standard amount of solar radiation and the standard temperature, the current conversion values become smaller than a standard operating current I_{OP_ST} defined as a product specification value for the standard amount of solar radiation and the standard temperature (FIG. 6C).

It is conceivable that the difference between the maximum power point and the current operating point in the current IV characteristics can be specified by converting the maximum power point and the current operating point in the current IV characteristics into values on the IV characteristics under the standard amount of solar radiation and the standard temperature (this conversion is called STC conversion) and identifying the difference between them. Specifically, a variable j for which the operating point after STC conversion becomes the standard maximum power point is searched for while changing the ratio of an operating current to a short circuit current (variable j to be described later). By specifying how much j changed from the initial value, the difference between the current operating point and the maximum power point on the current IV characteristics can be expressed by the specified variable j. Further, as will be described later, the expected amount of solar radiation can be determined in that process. These specific calculation procedures will be described below.

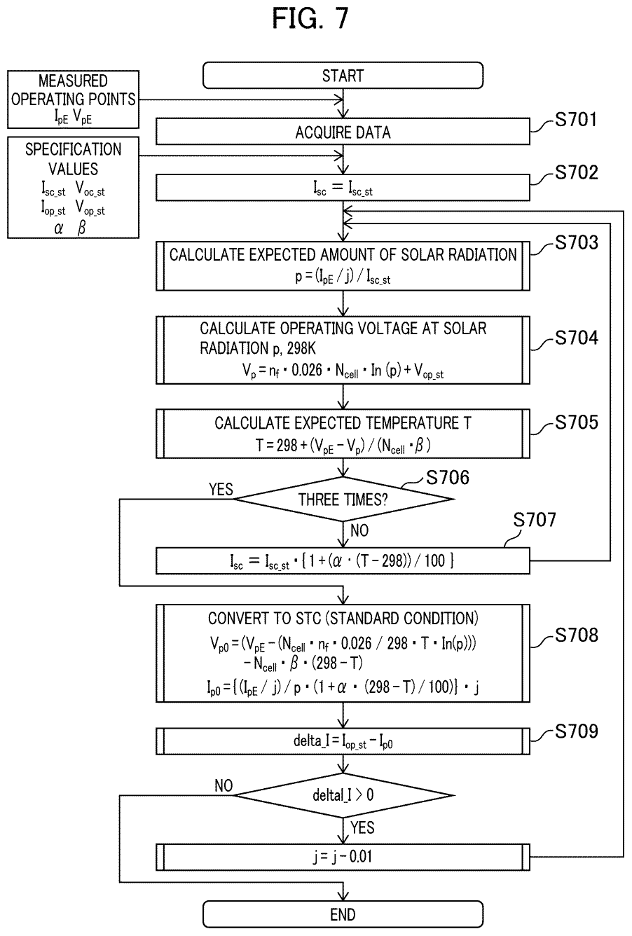

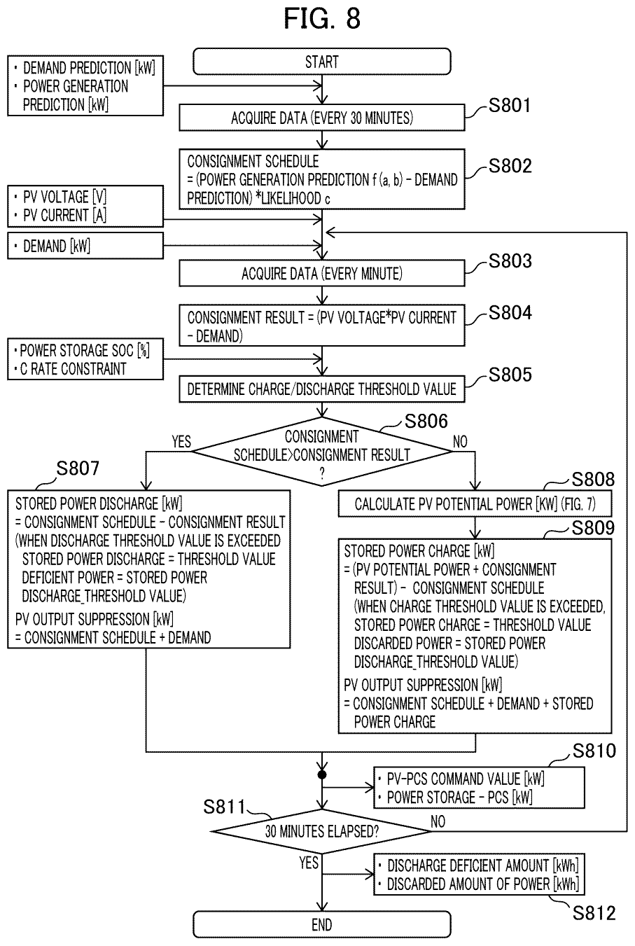

FIG. 7 is a flowchart describing a procedure of estimating a variable j and the expected amount of solar radiation. Each step in FIG. 7 will be described below. The process of deriving a calculation formula in each step will be described later. FIG. 7 is based on the following formula 1. At a voltage V, a solar cell type configured with the number of cells as N_{cell} can be expressed by the following formula 1. I: output current of solar battery cell [A], Is: reverse saturation current of diode [A], V: output voltage of solar battery cell [V], I_{SC}: short circuit current [A], T: absolute temperature of solar battery cell [K], k: Boltzmann constant, q: amount of charge of electron [C], nf: junction constant, and p: amount of solar radiation [kW/m²].

$$I = Isc \cdot p - Is \cdot \{ exp ( ( q \cdot ( V / {N}_{cell} ) ) / ( {n}_{f} \cdot k \cdot T ) ) \} \qquad ( 1 )$$

### (FIG. 7: Step S701)

The electric power control device 1 acquires measurement data describing the operating voltage V_{PE} and operating current I_{PE} of the solar cell. The solar cell referred to here is a battery which is the subject of diagnosis. The electric power control device 1 further acquires specification data describing specification values of the solar cell. The specification data describes the following specification values. (a) short circuit current: I_{SC_ST}, (b) open circuit voltage: V_{OC_ST}, (c) optimum operating current: I_{OP_ST}, (d) optimum operating voltage: V_{OP_ST}, and (e) coefficients in a calculation formula described later: α and β. Here, α is the temperature characteristic of the short circuit current [%/° C.], and β is the temperature characteristic of the operating voltage [mV/° C.]. The specification data may be obtained from the power conditioner, for example, or may be stored in advance in a storage device included in the electric power control device 1. It may be also acquired by other suitable means.

### (FIG. 7: Step S702)

The electric power control device 1 initializes the short circuit current I_{SC} based on the specification value I_{SC_ST}.

### (FIG. 7: Step S703)

FIG. 7 is based on the assumption that a sensor detecting the amount of solar radiation on the solar cell and a sensor detecting the temperature of the solar cell are not used. Therefore, the electric power control device 1 calculates the expected amount of solar radiation p for the solar cell. The expected amount of solar radiation p can be expressed as the ratio of the short circuit current at the time of the current amount of solar radiation to the short circuit current I_{SC_ST} at the time of the standard amount of solar radiation. Since the current operating current at the current amount of solar radiation is I_{PE}, the short circuit current at the current amount of solar radiation can be defined as I_{PE}/j. Therefore, the expected amount of solar radiation p is expressed by (the short circuit current at the current amount of solar radiation)/I_{SC_ST}, i.e., the following formula 2. Using this formula is useful when there are circumstances that make it impossible to identify the maximum power operating point at the current amount of solar radiation.

### (FIG. 7: Step S703: Calculation Formula)

$$P = ( {I}_{PE} / j ) / {I}_{SC \_ ST} \qquad ( 2 )$$

j=(operating current at the current operating point at the current amount of solar radiation)/(short circuit current at the current amount of solar radiation)

### (FIG. 7: Step S704)

The electric power control device 1 uses kT/q=0.026 at 298K in the formula 1 to calculate an operating voltage Vp at the expected amount of solar radiation p and battery temperature T=298K according to the following formula.

### (FIG. 7: Step S704: Calculation Formula)

$${V}_{P} = {n}_{f} \cdot 0.026 \cdot {N}_{cell} \cdot In ( p ) + {V}_{op \_ ST}$$

### (FIG. 7: Step S705)

The electric power control device 1 calculates the expected temperature T of the solar cell according to the following formula 7. β is generally a temperature characteristic of silicon and is about-2 mV/K.

### (FIG. 7: Step S705: Calculation Formula)

$$T = 298 + ( {V}_{PE} - {V}_{P} ) / ( {N}_{cell} \cdot β ) \qquad ( 7 )$$

### (FIG. 7: Step S706)

When the electric power control device 1 has repeated S703 to S705 a predetermined number of times or more (for example, three times), it skips to Step S708. When the electric power control device 1 has not repeated them, it returns to Step S703 after execution of S707.

### (FIG. 7: Step S707)

The electric power control device 1 updates the short circuit current I_{SC} according to the following formula, and returns to Step S703.

### (FIG. 7: Step S707: Calculation Formula)

$${I}_{SC} = {I}_{SC \_ ST} \cdot \{ 1 + ( a \cdot ( T - 298 ) ) / 100 \}$$

### (FIG. 7: Step S708)

The electric power control device 1 converts the operating voltage V_{PE} and the operating current I_{PE} into values (V_{P0}, I_{P0}) under the standard amount of solar radiation and the standard temperature according to the following formulas, respectively.

### (FIG. 7: Step S708: Calculation Formulas)

$${V}_{P 0} ( {V}_{PE} - {N}_{cell} \cdot {n}_{f} \cdot 0.026 / 298 \cdot T \cdot In ( p ) ) ) - {N}_{cell} \cdot β \cdot ( 298 - T )$$

$${I}_{P 0} = \{ ( {I}_{PE} / j ) / p \cdot ( 1 + α \cdot ( 298 - T ) / 100 ) \} \cdot j$$

### (FIG. 7: Step S709)

The electric power control device 1 determines whether or not I_{P0} calculated in S708 is larger than the standard operating current I_{OP_ST}. When I_{OP_ST} is larger than that, the electric power control device 1 decrements j and returns to S703. When not so (that is, when I_{P0} and I_{OP_ST} have reached where they substantially match), this flowchart is terminated.

### (FIG. 7: Steps S703 and S709: Supplement)

The initial value of j in S703 is taken as a value assuming the maximum power point on the current IV characteristic (the second white circle from the bottom in FIG. 6C). Decrementing j corresponds to moving closer to the current operating point from the maximum power point on the current IV characteristics, and corresponds to moving closer to the standard maximum power point on the IV characteristics after STC conversion.

### First Embodiment: Derivation Process of Calculation Formula in S704

In the formula 1, when I_{SC}=I_{SC_ST}, kT/q=0.026 at 298K, and I=I_{SC_ST}·p·j are used, F_{SC}V_{P} can be expressed by the following formula 3.

$${V}_{P} = {n}_{f} \cdot 0.026 \cdot In ( ( ( 1 - j ) \cdot {I}_{SC \_ ST} \cdot p ) / {I}_{S} ) \qquad ( 3 )$$

The standard operating voltage V_{OP_ST} at p=1.0 is expressed by the following formula 4.

$${V}_{OP \_ ST} = {n}_{f} \cdot 0.026 \cdot In ( ( ( 1 - j ) \cdot {I}_{SC \_ ST} ) / {I}_{S} ) \qquad ( 4 )$$

Subtracting formula 4 from formula 3 to calculate the voltage difference yields the following formula 5.

$${V}_{P} - {V}_{OP \_ ST} = {n}_{f} \cdot 0.026 \cdot In ( p ) \qquad ( 5 )$$

Therefore, the following formula 6 can be derived. This formula 6 is used in S704.

$$\begin{matrix}{V}_{P} = ( {V}_{P} - {V}_{OP \_ ST} ) + {V}_{OP \_ ST} \\ = {n}_{f} \cdot 0.026 \cdot In ( p ) + {V}_{OP \_ ST}\end{matrix} \qquad ( 6 )$$

### First Embodiment: Derivation Process of Calculation Formula in S708

The STC has a solar radiation amount of 1.0 kW/m² and a temperature of 298K. When a reverse saturation current at the temperature T is I_{S_T}, the formula 3 is transformed to obtain formulas 8 and 9 described below.

$${V}_{PE} = {n}_{f} \cdot 0.026 / 298 \cdot T \cdot In ( ( 1 - j ) \cdot Isc \cdot p ) / {I}_{S \_ T} ) \qquad ( 8 )$$

$${V}_{P 1} = {n}_{f} \cdot 0.026 / 298 \cdot T \cdot In ( ( 1 - j ) \cdot {I}_{SC} ) \cdot {I}_{S \_ T} ) \qquad ( 9 )$$

Subtracting formula 9 from formula 8 yields the following formula 10.

$${V}_{PE} - {V}_{P 1} = {n}_{f} \cdot 0.026 / 298 \cdot T \cdot In ( p ) \qquad ( 10 )$$

Therefore, V_{P1} can be expressed by the following formula 11.

$$\begin{matrix}{V}_{P 1} = ( {V}_{PE} - {V}_{P 1} ) \\ = {V}_{PE} - {n}_{f} \cdot 0.026 / 298 \cdot T \cdot In ( p )\end{matrix} \qquad ( 11 )$$

When V_{P1} is converted to V_{P0} at room temperature, the following formula 12 is obtained. Substituting formula 11 into formula 12 yields the calculation formula in S708.

$${V}_{P 0} = {V}_{P 1} - β \cdot {N}_{cell} \cdot ( 298 - T ) \qquad ( 12 )$$

After calculating V_{P0}, I_{P0} is determined. I_{SC} at the temperature T is expressed by the following formula 13.

$${I}_{SC} = ( {I}_{PE} / j ) / p \qquad ( 13 )$$

When I_{SC} is returned to I_{SC}0 at room temperature, the following formula 14 is obtained.

$${I}_{SC} 0 = ( ( {I}_{PE} / j ) / p ) \cdot ( 1 + α \cdot ( 298 - T ) / 100 ) \qquad ( 14 )$$

Therefore, I_{P0} is expressed by the following formula 15. This formula 15 is used in S708.

$$\begin{matrix}{I}_{P 0} = {I}_{SC} 0 \cdot j \\ = j \cdot ( ( {I}_{PE} / j ) / p ) \cdot ( 1 + α \cdot ( 298 - T ) / 100 )\end{matrix} \qquad ( 15 )$$

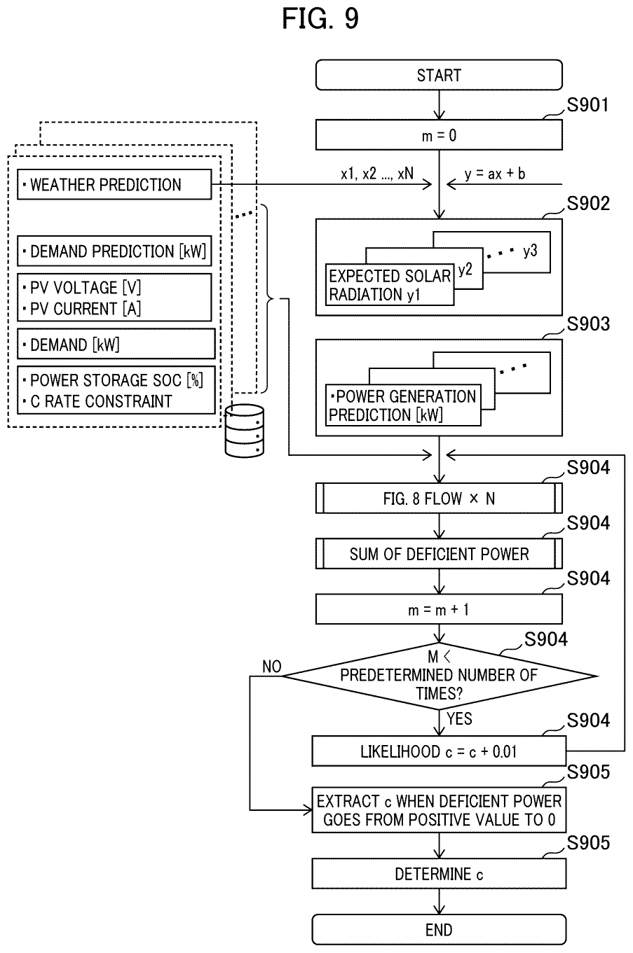

FIG. 8 is a flowchart describing a procedure by which the electric power control device 1 suppresses power transmission imbalance while implementing self-consignment. The present flowchart can be performed, for example, at the same time interval as S801 during the period in which self-consignment is being carried out. Each step in FIG. 8 will be described below.

### (FIG. 8: Step S801)

The electric power control device 1 acquires power demand prediction data and power generation prediction data. These data are acquired at every time interval (30 minutes in this example) at which it is necessary to describe a consignment plan. The power demand prediction data can be acquired from, for example, a power transmission destination site (site B in FIG. 2). The power generation prediction data can be acquired by the method described in FIGS. 4A and 4B.

### (FIG. 8: Step S802)

The electric power control device 1 subtracts the demand prediction from the power generation prediction and multiplies the subtraction result by the likelihood c to thereby calculate the scheduled power to be consigned. The scheduled power to be consigned is calculated at the same time interval as in S801.

### (FIG. 8: Step S803)

The electric power control device 1 acquires the output voltage of the solar cell, the output current of the solar cell, and power demand data. The data acquired in the present step is actually measured values at time intervals shorter than in S801 (1 minute in this example). In other words, the present flowchart is for implementing control using electric power rather than the amount of power by implementing the following steps using instantaneous power values every minute.

### (FIG. 8: Step S804)

The electric power control device 1 calculates a consignment result for each time interval in S803 based on the data acquired in S803. Specifically, the consigned power can be calculated by subtracting the power demand at that time interval from the result of multiplying the output voltage of the solar cell and the output current of the solar cell.

### (FIG. 8: Step S805)

The electric power control device 1 acquires an SOC (State Of Charge) and C rate constraints of the storage battery from, for example, a battery management unit (BMU). The electric power control device 1 uses these values to determine a threshold value when the storage battery during the consignment time is charged or discharged. For example, the upper and lower limits of the SOC determine constraints (threshold values) on the capacity of the storage battery after charging and discharging, and the upper and lower limits of the C rate determine constraints (threshold values) on the speed at which the storage battery is charged and discharged (that is, the power input and output to and from the storage battery by charging and discharging operations). For example, in the case where the storage battery fails when all amount of surplus power generated by the solar cell is used to charge the storage battery, the upper limit constraint on the charging C rate can be used.

### (FIG. 8: Step S806)

The electric power control device 1 compares the scheduled power to be consigned calculated in S802 and the consignment result power calculated in S804. When the scheduled power to be consigned is larger, the electric power control device 1 proceeds to S807; otherwise, it advances to S808.

### (FIG. 8: Step S807: Part 1)

The electric power control device 1 determines the result of subtracting the consignment result power from the scheduled power to be consigned as the electric power to be discharged from the storage battery. Consequently, a shortfall in the power actually generated by the solar cell is compensated for by discharge from the storage battery. However, when the calculated discharge power exceeds the discharge power threshold value determined in S805, the discharge power is set to the discharge power threshold value. In this case, the power to be discharged from the storage battery becomes short. The power shortage is determined by subtracting the discharge power threshold value from the calculated discharge power.

### (FIG. 8: Step S807: Part 2)

The electric power control device 1 further determines the output power of the solar cell. In the present step, since the power generated by the solar cell is insufficient compared to the scheduled power to be consigned, it is necessary to increase the output power of the solar cell. Since the remaining portion after subtracting the power demand from the output of the solar cell is scheduled to be consigned, there is a need to specify the result of adding the demand to the scheduled power to be consigned, as the output of the solar cell in order to comply with the scheduled power to be consigned.

### (FIG. 8: Step S808)

In the present step, the consignment result power is larger than the scheduled power to be consigned, that is, the solar cell has a surplus of output power. This corresponds to the solar cell operating with output power smaller than the maximum power point. Therefore, the electric power control device 1 calculates the output power (hereinafter referred to as potential power) assumed to be further outputtable by the solar cell operating at the maximum power point. The potential power can be calculated by obtaining the maximum power point in the process of implementing the flowchart of FIG. 7. Therefore, the electric power control device 1 calculates the potential power through the implementation of the flowchart of FIG. 7. A specific calculation procedure will be described later.

### (FIG. 8: Step S809: Part 1)

The electric power control device 1 determines the result of subtracting the scheduled power to be consigned from the consignment result power and adding the potential power as the power to be charged to the storage battery. Thus, the surplus power actually generated by the solar cell can be consumed by charging the storage battery. However, when the calculated charging power exceeds the charging power threshold value determined in S805, the charging power is set to the charging power threshold value. In this case, even if the storage battery is charged, there will be still generated surplus power. The surplus power is obtained by subtracting the charging power threshold value from the calculated charging power. The surplus power will be discarded.

### (FIG. 8: Step S809: Part 2)

The electric power control device 1 determines the output power of the solar cell. In the present step, since there is a possibility that the solar cell has a power generation surplus, the output power is determined in consideration of the power generation surplus. In order to comply with the schedule power to be consigned, there is a need to designate at least the result of adding the demand to the scheduled power to be consigned, as the output of the solar cell. Further, the result of adding the surplus power (potential power in S808) is designated as the solar cell output.

### (FIG. 8: Step S810)

The electric power control device 1 instructs the drive device of the solar cell (device comprised of the converter in the example of each of FIGS. 1A and 1B) to take the output power determined in S807 or S808 as a command value. The electric power control device 1 further instructs the drive device of the storage battery (device comprised of the converter in the example of each of FIGS. 1A and 1B) to take the charging/discharging power determined in S807 or S808 as a charging/discharging command value.

### (FIG. 8: Steps S811 and S812)

The electric power control device 1 repeatedly performs S803 to S810 until the time interval of the consignment plan (30 minutes in this example) is reached. When it is reached, the insufficient power discharged from the storage battery (when performing S807) or the surplus power still remaining after charging the storage battery (when performing S808) is recorded.

### <First Embodiment: Details of S808)

The electric power control device 1 determines the operating point (I′p, V′p) after STC conversion when the output of the solar cell is suppressed, in accordance with the following calculation formulas. This operating point is obtained by subjecting the bottom white circle in FIG. 6(c) to STC conversion. In the calculation formulas, j is a variable j determined by the flowchart in FIG. 7. Here, j0 is the ratio of the operating current at the maximum power point at the standard amount of solar radiation and the standard temperature to the short circuit current at the standard amount of solar radiation and the standard temperature. Further, r is the ratio between the maximum power and the current operating power when converted to the standard amount of solar radiation and the standard temperature. The potential power can be calculated by multiplying the operating power (IpE×VpE) before STC conversion by this ratio. However, in the present flowchart, since the potential power is obtained as the amount suppressed from the maximum power (the difference between the maximum power and the current power), it is multiplied by (r−1) in this calculation formula.

$${I}^{′} p = {I}_{sc \_ st} \times j$$

$${V}^{′} p = nf \cdot 0.026 \cdot Ncell \cdot In ( ( {I}_{sc \_ st} \cdot ( 1 - j ) / ( {I}_{sc \_ st} \cdot ( 1 - j 0 ) ) + {V}_{op \_ st}$$

$$j 0 = {I}_{op \_ st} / {I}_{sc \_ st}$$

$$r = ( {I}_{op \_ st} \times {V}_{op \_ st} ) / ( {I}^{′} p \times {V}^{′} p )$$

$$potential power = ( IpE \times VpE ) \times ( r - 1 )$$

I_{sc_st}: short circuit current at standard amount of solar radiation and standard temperature
I_{op_st}: battery current at maximum power point at standard amount of solar radiation and standard temperature
V_{op_st}: battery voltage at maximum power point at standard amount of solar radiation and standard temperature

FIG. 9 is a flowchart describing a procedure for determining the likelihood c. The penalty of failing to comply with the consignment plan is particularly large when the actual transmission power is insufficient compared to the planned power. Therefore, the present flowchart searches for the likelihood c which causes no such power shortage. The present flowchart can be executed, for example, during a period when the electric power control device 1 is not executing self-consignment. For example, this can be performed every time each data acquired in S902 and S903 is accumulated for a predetermined number of days. Each step in FIG. 9 will be described below.

### (FIG. 9: Steps S901 to S903)

The electric power control device 1 initializes the number of repetitions m (S901). The electric power control device 1 acquires weather prediction data for each consignment period x1 to xN. The electric power control device 1 acquires the expected amount of solar radiation (S902) and power generation prediction (S903) for each consignment period using the method described in FIGS. 4A and 4B.

### (FIG. 9: Step S904)

The electric power control device 1 executes the flowchart of FIG. 8 for each consignment period. Based on the result of its execution, the electric power control device 1 specifies the shortage of power output by the solar cell during the consignment period and adds them together. The electric power control device 1 increments the number of repetitions m. The electric power control device 1 repeatedly increments the likelihood c (for example, by 0.01) and returns to S904 until m reaches a predetermined number of times.

### (FIG. 9: Step S904: Supplement)

In the present step, instead of or in addition to incrementing the likelihood c, the coefficients (inclination a and an intercept b in the example of FIG. 4A) which describe the learning results described in FIG. 4A may be changed. This allows a search range to be further expanded.

### (FIG. 9: Step S905)

In the process of repeating S904, the electric power control device 1 specifies the likelihood c when the total value of power shortages goes from a positive value to 0. For example, when c=0.90, the power shortage is a small positive value, and when the power shortage becomes 0 when c=0.91, c=0.91 is specified. The electric power control device 1 adopts this c as the likelihood. As long as there is no power shortage, such c may be adopted that the amount of power generated by the solar cell is in surplus.

### Second Embodiment

The electric power control device 1 described in the first embodiment can include the calculation unit 11 which executes the operations described in FIGS. 3 to 8. The calculation unit 11 can also be configured using hardware such as a circuit device having implemented its function, or can also be configured by causing a calculation device such as a CPU (Central Processing Unit) to execute software having implemented the function. The electric power control device 1 can further include a storage unit 12 which stores a history of each data (e.g., power generation amount prediction data, demand data, demand prediction data, etc.) described in the first embodiment.

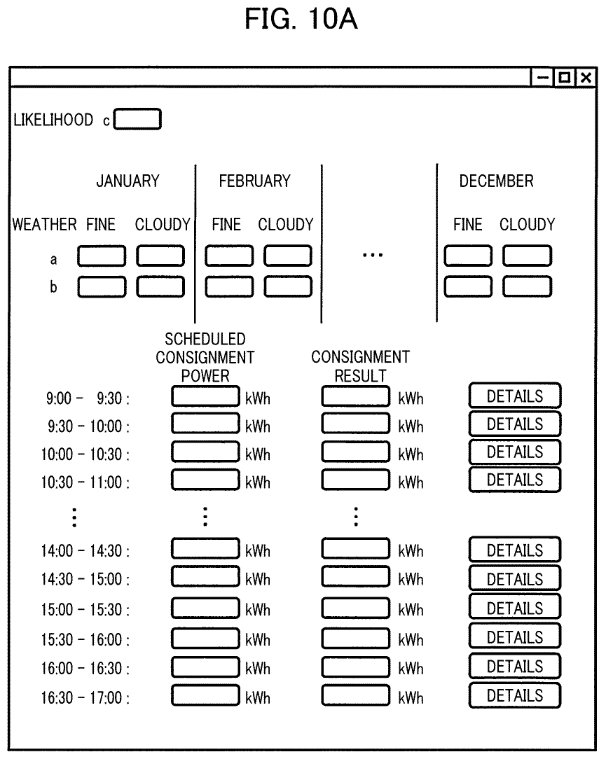

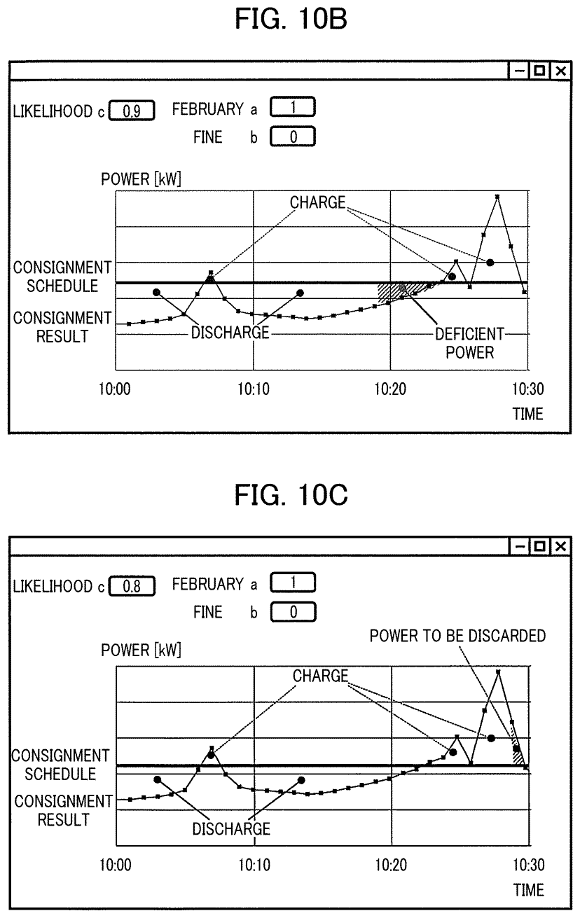

FIGS. 10A to 10C are examples of the user interface provided by the electric power control device 1. The user interface can be presented by the calculation unit 11 on a display device such as a display or the like. The user interface can present, for example, numerical values for the scheduled power to be consigned and the consignment result for each consignment period (FIG. 10A), detailed graphs descriptive of their changes with time (FIGS. 10B to 10C), etc. Further, the power shortage and the surplus power can also be illustrated (power shortage in FIG. 10B and discarded power in FIG. 10C).

### <Modification of the Present Invention>

It should be noted that the present invention is not limited to the embodiment described above, and includes various modification embodiments. For example, the embodiments described above have been described in detail to simply describe the present invention, and are not necessarily required to include all the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

1: electric power control device
11: calculation unit
12: storage unit

1. An electric power control device which controls transmitted power when power generated by a power generation system comprising a solar cell and a storage battery is transmitted between sites via a power transmission network, the electric power control device comprising:
a calculation unit which calculates the transmitted power, wherein
the calculation unit acquires planned power representing power that the power generation system is scheduled to output to the power transmission network during a power transmission period in which the power transmission is executed,
the calculation unit acquires actual resulting power representing the power output by the power generation system to the power transmission network during the power transmission period,
the calculation unit calculates power to be charged or discharged by the storage battery based on a difference between the planned power and the actual resulting power during the power transmission period, and
the calculation unit calculates power that the solar cell needs to generate during the power transmission period based on the difference.

2. The electric power control device according to claim 1, wherein
the calculation unit acquires power demand during the power transmission period,
the calculation unit subtracts the power demand from the result of multiplying an output voltage of the solar cell and an output current of the solar cell to calculate the actual resulting power, and
when the planned power is larger than the actual resulting power, the calculation unit determines the difference between the planned power and the actual resulting power as power to be discharged from the storage battery.

3. The electric power control device according to claim 1, wherein
the calculation unit acquires power demand during the power transmission period,
the calculation unit subtracts the power demand from the result of multiplying an output voltage of the solar cell and an output current of the solar cell to calculate the actual resulting power, and
when the actual resulting power is greater than or equal to the planned power, the calculation unit determines power to be charged by the storage battery based on the difference between the actual resulting power and the planned power.

4. The electric power control device according to claim 3, wherein
the calculation unit calculates a first difference between the actual resulting power and the planned power,
the calculation unit calculates a second difference between the maximum power that the solar cell is capable of generating and power actually generated by the solar cell, and
the calculation unit adds the second difference to the first difference to determine power to be charged by the storage battery.

5. The electric power control device according to claim 4, wherein
while changing an operating current of the solar cell, the calculation unit performs a convergence calculation so that converted maximum power obtained by converting the maximum power into a value assuming that the solar cell is operating under a standard amount of solar radiation and a standard temperature, and converted actual generated power obtained by converting the actual generated power into a value assuming that the solar cell is operating under a standard amount of solar radiation and a standard temperature match each other, and
the calculation unit calculates the second difference using the operating current of the solar cell obtained in the process of the convergence calculation.

6. The electric power control device according to claim 5, wherein
the calculation unit performs the convergence calculation while changing a first ratio of an operating current of the solar cell to a short circuit current of the solar cell to determine the first ratio at which the converted maximum power and the converted actual generated power match,
the calculation unit determines a second ratio of an operating current of the solar cell to a short circuit current of the solar cell when the solar cell operates at the maximum power point at the standard amount of solar radiation and the standard temperature,
the calculation unit calculates the converted actual generated power by using the first ratio obtained by the convergence calculation and the second ratio,
the calculation unit calculates a third ratio between the converted maximum power and the converted actual generated power calculated using the first and second ratios, and
the calculation unit applies the third ratio to the output current of the solar cell and the output voltage of the solar cell to calculate the second difference.

7. The electric power control device according to claim 1, wherein
the calculation unit calculates an expected amount of solar radiation for the solar cell using the output voltage of the solar cell and the output current of the solar cell,
the calculation unit specifies a result of estimating the temperature of the solar cell as an expected temperature, and
the calculation unit predicts the amount of power generated by the solar cell using the expected amount of solar radiation and the expected temperature to calculate the planned power.

8. The electric power control device according to claim 7, wherein
the calculation unit converts the output voltage of the solar cell and the output current of the solar cell into a converted standard current and a converted standard voltage converted into values assuming that the solar cell is operating under a standard amount of solar radiation and a standard temperature, and
the calculation unit repeats the conversion until the difference between a standard current when the solar cell is operating under the standard amount of solar radiation and the standard temperature and the converted standard current converges, to specify the expected amount of solar radiation and the expected temperature.

9. The electric power control device according to claim 1, wherein
the calculation unit calculates an expected amount of solar radiation for the solar cell using the output voltage of the solar cell and the output current of the solar cell,
the calculation unit acquires a measured value of the amount of solar radiation,
the calculation unit learns a correspondence relation between the expected amount of solar radiation and the measured value,
the calculation unit applies the newly acquired measured value to the learned correspondence relation to specify a result of predicting an amount of solar radiation irradiated to the solar cell as a predicted amount of solar radiation, and,
the calculation unit calculates the planned power by predicting an amount of power generated by the solar cell using the predicted amount of solar radiation.

10. The electric power control device according to claim 1, wherein
the calculation unit subtracts the power demand during the power transmission period from the predicted amount of power generation of the solar cell during the power transmission period to calculate a candidate value of the planned power,
the calculation unit calculates a difference between the planned power and the actual resulting power using a result of multiplying the planned power by a coefficient representing a rate at which the power generation capacity of the solar cell is suppressed,
the calculation unit searches for the coefficient capable of compensating for the difference between the planned power and the actual resulting power by discharging the storage battery, and
the calculation unit calculates the power to be discharged by the storage battery using the searched coefficient.

11. The electric power control device according to claim 10, wherein
the calculation unit calculates an expected amount of solar radiation for the solar cell using the output voltage of the solar cell and the output current of the solar cell,
the calculation unit acquires a measured value of the amount of solar radiation,
the calculation unit learns a correspondence relation between the expected amount of solar radiation and the measured value,
the calculation unit applies the newly acquired measured value to the learned correspondence relation to specify a result of predicting an amount of solar radiation irradiated to the solar cell as a predicted amount of solar radiation,
the calculation unit calculates the planned power by predicting an amount of power generated by the solar cell using the predicted amount of solar radiation, and
the calculation unit searches for the coefficient while changing the correspondence relation.

12. The electric power control device according to claim 10, further including a storage unit which stores data describing a history of each of the predicted amount of power generation and the power demand, wherein
the calculation unit performs the search anew every time the data is accumulated for a predetermined number of days.

13. The electric power control device according to claim 1, wherein
the calculation unit outputs a user interface, and
the user interface is configured to present at least any of:
the planned power,
the actual resulting power,
the power that the storage battery needs to charge or discharge during the power transmission period, or
the power that the solar cell needs to generate during the power transmission period.
